(19) United States
(12) Patent Application Publication
(10) Pub. No.: US 2024/0109444 A1
(43) Pub. Date: Apr. 4, 2024

(54) VARIABLE WALLBOX

(71) Applicant: AUDI AG, Ingolstadt (DE)

(72) Inventors: Jürgen HORVATH, Wiesenfelden (DE); Franz LANKES, Ingolstradt (DE)

(21) Appl. No.: 18/475,049

(22) Filed: Sep. 26, 2023

(30) Foreign Application Priority Data
Sep. 27, 2022 (DE) 102022124842.9

(51) Int. Cl. B60L 53/35; B60L 53/65; H02J 7/00

(52) U.S. Cl. CPC B60L 53/35; B60L 53/65; H02J 7/0042

(57) ABSTRACT

A wall-mounted charging station is provided for charging an energy storage of an electric vehicle. A method for operation of such a wall-mounted charging station is also provided.

### BACKGROUND

### Technical Field

Embodiments of the invention relate to a wall-mounted charging station for charging an energy storage of an electric vehicle as well as a method for its operation.

### Description of the Related Art

A wallbox firmly mounted at one point is often used as the charging point for electric vehicles in a garage, a parking structure, etc. It may happen that the position of the firmly mounted wallbox does not optimally suit the charging socket of the vehicle. In parking structures or underground garages, a fixed position of a wallbox may constrain the parking direction (forward parking, backward parking), which might make it difficult for the user of the vehicle to get into and out from the vehicle. If a wallbox is firmly mounted in a private garage, the position of the firmly mounted wallbox might no longer suit or be optimal for the charging socket of the vehicle in event of a change of tenants or change of vehicles. A building modification is required, which generally must be done by an electrician. Repositioning of the wallbox may result in additional boreholes in the walls, which might cause structural damage to the walls, especially in the case of finished garages.

WO 2013 025 905 A2 relates to a charging station for charging multiple vehicles and a method for the charging of energy storage systems in multiple vehicles. A charging station for the charging of multiple vehicles, each of which has a receiver coil arranged on a vehicle, comprises: a first and a second support structure, an overhead track extending between the first and the second support structure, a movable carriage on the overhead track, wherein the cart comprises a transmitter coil situated at a position beneath the cart for the transmission of energy to the receiver coils of the multiple vehicles when they are parked under the overhead track, and an inductive energy transmission module connected to the transmission coil and a motorized transport mechanism for moving the cart along the rail and for positioning the cart above any one of the multiple vehicles which is selected.

CN 114161962 A discloses an automatic charging garage system for an electric vehicle, with which the position of a vehicle charging socket can be located quickly and efficiently. The automatic charging garage system for electric vehicles comprises a garage, a charging movement system, an adjustment base and a connector cable box. The charging movement system is installed in the garage, the adjustment base is installed on the charging movement system by bolts, and the connector cable box is installed on the adjustment base by screws. The charging movement system is used to drive the connector cable box so that it is stable in movement. The adjustment base is coordinated with the charging movement system, so that the vehicle can move at a right angle with no friction, the movement is stable, the positioning charging can be performed both when traveling and during backward parking, and the area of application is broad.

US 2010/102 775 A1 discloses a retractable overhead charging cable dispenser having a multiple positioning ability for providing plug-in electric current for PHEVs which are parked at different positions in a garage or the like. One embodiment of the retractable overhead charging cable dispenser comprises an arm assembly, a cable guide arm carried by the arm assembly, a cable stowage device provided in the arm assembly, and a retractable charging cable which can be pulled out from the cable stowage device which extends therethrough and sticks out from the cable guide arm.

### BRIEF SUMMARY

The present disclosure provides devices and methods for the charging of an electric vehicle, in which the charging point can be variably positioned in order to organize the charging process of the vehicle more easily and comfortably.

Embodiments may include a charging station for an electric vehicle, which is adapted to be mounted on a building wall. The charging station may comprise a rail system having at least one rail and a charging device able to move along the at least one rail on the rail system as well as a trailing cable connected to the charging device, which may run within the rail system along the at least one rail and may be connected to a connection point of a power supply.

The charging station may comprise a rail system having a movable charging unit (wallbox), which can be mounted on walls, ceilings, or other load-bearing structures. The rail system may be mounted on the surface of a building wall (surface mounting). In some embodiments, the rail system may be mounted on an inner wall of a building. In some embodiments, the rail system may be mounted on outer wall of a building. In some embodiments, the rail system may be mounted such that the at least one rail runs horizontally, i.e., parallel to the floor. In some embodiments, the rail system may be mounted such that the at least one rail runs vertically, i.e., perpendicular to the floor. Such embodiments may provide protection against vandalism, since the charging device may travel upward into a position out of reach when not in use.

The rail system may comprise at least one rail. In some embodiments, the rail system may comprise two parallel running rails.

The charging station may comprise a charging device (wallbox) able to move along the at least one rail on the rail system. The wallbox can thus be moved as needed for the particular situation (e.g., change of vehicles, shared parking space, changed parking position such as forward parking and backward parking).

The cable which is required for the power supply of the wallbox may be guided in a trailing cable, which may run along the rail within the rail system. In some embodiments, the rail system may comprise two parallel running rails and the trailing cable may run between the rails. The trailing cable may be used within the rails for the power supply of the wallbox from the (main) connection point for electricity. A conventional existing wallbox can also be mounted on the rail system.

In some embodiments of the charging station, the charging device (the wallbox) may be moved manually on the rail system. In some embodiments, the charging station may comprise a motor drive unit which is adapted to moving the charging device along the at least one rail.

In some embodiments, the charging station may comprise a controller which is adapted to control the motor drive unit and to move the charging device into a given position. Such embodiments allow an automatic instead of a manual positioning of the wallbox. The wallbox or the at least one rail may be provided with a motor drive unit in order to move the wallbox automatically.

In some embodiments, the controller may be configured to save multiple given positions for the charging device and to move the charging device into a position selected from among the saved positions.

In some embodiments, the selection from among the positions saved in the controller may be done by user input. In some embodiments, the controller may possess means of automatic vehicle recognition and the selection from among the positions saved in the controller is done by an automatic vehicle recognition. In some embodiments, the means for automatic vehicle recognition may comprise a reader for RFID transponders. Through vehicle recognition, such as by RFID, the wallbox can drive automatically to a desired position, for example when several people are sharing a parking place.

In some embodiments, the rail can may curve around corners in order to also position the wallbox around corners. In such embodiments, no trailing cable can be used and the power supply will come, for example, via protected current consumers in the rail.

Some embodiments include a method for charging an electric vehicle with a charging station. The charging device prior to the charging process may be moved along the at least one rail into a position in proximity to a charging socket of the electric vehicle and then the charging socket of the vehicle is connected to the charging device and the charging process is carried out.

Among the benefits of the solution described herein are the fact that the wallbox can be positioned at any given place along the rail. In this way, the wallbox can be placed each time in the most suitable position for the charging without major installation work and further installation costs for different vehicles. This is especially advantageous in the case of parking places with large fluctuation of the vehicles using them, such as apartment houses, underground garages, or parking structures. The users can be provided the additional benefit of getting more easily into and out from the vehicle, without being constricted by the charging device. Further benefits and embodiments of the variable wallbox described herein will emerge from the description and the accompanying drawing.

It is to be understood that the features mentioned above and those yet to be explained below can be used not only in the particular indicated combination, but also in other combinations or standing alone, without leaving the scope of the present disclosure.

### BRIEF DESCRIPTION OF THE SEVERAL VIEWS OF THE DRAWINGS

FIG. 1 shows a schematic representation of a charging station.

### DETAILED DESCRIPTION

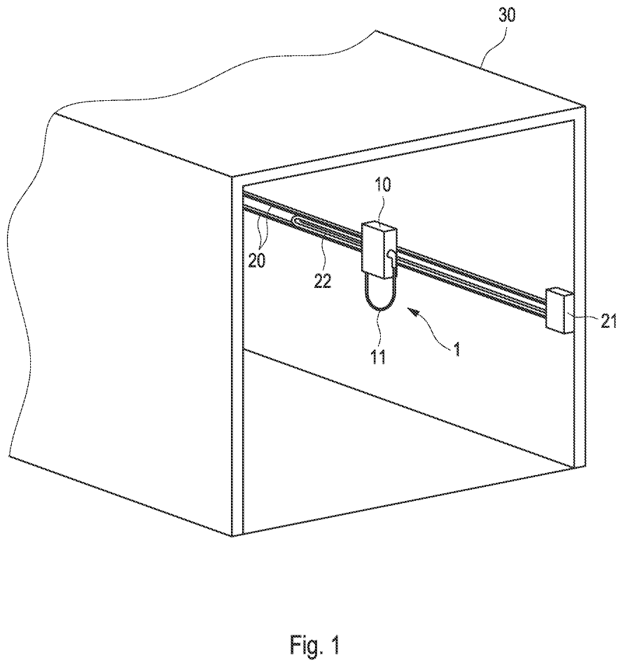

FIG. 1 shows a single garage 30 having a charging station 1 according to the invention. A wallbox 10 is mounted on a rail system 20. The rail system 20 is mounted on a side wall of the garage 30 parallel to the floor and comprises a connection point 21 for the power supply and a trailing cable 22 connected to the connection point 21 and the wallbox 10, which is led inside the rail system 20 and furnishes power to the wallbox 10. The wallbox 10 can be moved however desired along the rail system 20 in order to be placed in the optimal charging position for a vehicle being charged in the garage 30, in which the charging cable 11 of the wallbox 10 can be conveniently inserted into the charging socket of the vehicle. Due to the surface mounting, the rail system 20 can also be retrofitted in a garage 30 without major expense.

German patent application no. 10 2022 124842.9, filed Sep. 27, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A charging station for an electric vehicle, which is adapted to be mounted on a building wall, comprising:
a rail system having at least one rail;
a charging device configured to move along the at least one rail of the rail system; and
a trailing cable connected to the charging device, the trailing cable running within the rail system along the at least one rail and connected to a connection point of a power supply.

2. The charging station according to claim 1, wherein the rail system comprises two parallel running rails and wherein the trailing cable runs between the rails.

3. The charging station according to claim 1, comprising a motor drive unit configured to move the charging device along the at least one rail.

4. The charging station according to claim 3, comprising a controller configured to control the motor drive unit and to move the charging device into a given position.

5. The charging station according to claim 4, wherein the controller is configured to save multiple given positions for the charging device and to move the charging device into a position selected from the multiple given positions.

6. The charging station according to claim 5, wherein a position of the multiple given positions is selected by user input.

7. The charging station according to claim 5, wherein the controller is configured to automatically recognize vehicles and wherein a position of the multiple given positions is selected by automatic vehicle recognition.

8. The charging station according to claim 7, wherein the controller comprises a reader for RFID transponders and wherein the reader for RFID transponders is configured to automatically recognize vehicles.

9. The charging station according to claim 1, wherein the charging station is configured to be mounted on a building wall such that the rail system runs in the vertical direction.

10. A method for charging an electric vehicle with a charging station, comprising:
moving a charging device along at least one rail of a rail system into a position in proximity to a charging socket of the electric vehicle prior to a charging process;
connecting the charging socket of the vehicle to the charging device; and
beginning the charging process.
